(19) United States
(12) Patent Application Publication
(10) Pub. No.: US 2024/0176632 A1
(43) Pub. Date: May 30, 2024

(54) METHOD FOR GENERATING AND VERIFYING AUTOMOTIVE EMBEDDED SOFTWARE BASED ON AUTOSAR

(71) Applicant: DRIMAES, INC., Daegu (KR)

(72) Inventors: Anna YANG, Seongnam-si (KR); Woojin HAN, Seoul (KR); Won LEE, Okcheon-gun (KR); JongHyeon LEE, Okcheon-gun (KR); Inho LEE, Seoul (KR); Jisu KONG, Seoul (KR)

(21) Appl. No.: 18/065,590

(22) Filed: Dec. 13, 2022

(30) Foreign Application Priority Data
Nov. 25, 2022 (KR) 10-2022-0159936
Nov. 25, 2022 (KR) 10-2022-0159937

(51) Int. Cl. G06F 9/455; G06F 9/445

(52) U.S. Cl. CPC G06F 9/45508; G06F 9/44589

(57) ABSTRACT

Provided is a method for generating automotive embedded software based on AUTOSAR. The method includes: emulating RTE and BSW among layers constituting the AUTOSAR for the automotive embedded software to be verified to fit a predetermined test environment; verifying an operation of the automotive embedded software based on AUTOSAR implemented to correspond to a predetermined test target function; and loading the automotive embedded software into a target ECU when there is no abnormality as a result of the verification.

### CROSS-REFERENCE TO RELATED APPLICATION

This application claims priority to and the benefit of Korean Patent Application No. 10-2022-0159936, filed on Nov. 25, 2022, and Korean Patent Application No. 10-2022-0159937, filed on Nov. 25, 2022, the disclosure of which is incorporated herein by reference in its entirety.

### BACKGROUND

### 1. Technical Field

The present disclosure relates to a method for generating and verifying automotive embedded software based on AUTomotive Open System Architecture (AUTOSAR).

### 2. Related Art

Recently, as a vehicle changes like a computer from a mechanical structure, the importance of software for controlling the vehicle is further increasing and the complexity of the software is also continuously increasing.

To reduce this complexity and coupling, an AUTomotive Open System Architecture (AUTOSAR) standard was established to ensure reliability and reusability of automotive embedded software.

The AUTOSAR is a software standard platform for automotive electronics developed for the purpose of the reliability and reusability, and many vehicle companies are attempting to mount the platform developed based on AUTOSAR on vehicles.

Meanwhile, there is a problem that a lot of time and money are required in the traditional vehicle embedded software development process. As a result, there is a need to reduce the effort required to develop and verify automotive embedded software through modeling and simulation.

### SUMMARY

The present disclosure is intended to address a method for generating and verifying automotive embedded software based on AUTOSAR capable of generating and verifying automotive embedded software through a virtual environment when an image file of a target ECU does not exist.

However, the problems to be solved by the present disclosure are not limited to the problems described above, and other problems may be present.

According to a first aspect of the present disclosure, a method for verifying automotive embedded software based on AUTOSAR includes: emulating RTE and BSW among layers constituting the AUTOSAR for the automotive embedded software to be verified to fit a predetermined test environment; verifying an operation of the automotive embedded software based on AUTOSAR implemented to correspond to a predetermined test target function; and loading the automotive embedded software into a target ECU when there is no abnormality as a result of the verification.

In addition, according to a first aspect of the present disclosure, a method for verifying automotive embedded software based on AUTOSAR includes: virtualizing a binary file built to correspond to target ECU information through QEMU; emulating the automotive embedded software based on the AUTOSAR to be verified on the virtualized ECU (hereinafter, referred to as a virtual ECU) to fit a predetermined test environment; verifying an operation of the automotive embedded software based on AUTOSAR implemented to correspond to a predetermined test target function; and loading the automotive embedded software into a target ECU when there is no abnormality as a result of the verification.

In addition, according to a third aspect of the present disclosure, a method for generating automotive embedded software based on AUTOSAR includes emulating RTE and BSW among layers constituting the AUTOSAR for the automotive embedded software according to fit a predetermined test environment, in which FMI is supported in the BSW among the layers of the AUTOSAR.

In addition, according to another aspect of the present disclosure, a computer program is combined with a computer, which is hardware, to execute the method for verifying automotive embedded software based on AUTOSAR, and is stored in a computer readable recording medium.

Other specific details of the invention are contained in the detailed description and drawings.

According to the present disclosure described above, by performing software self-verification and verification that imitates a target ECU environment before loading into the actual ECU, it is possible to perform development and verification only with the software itself even in an environment where hardware does not exist, so the time and cost required for the development and verification process of automotive embedded software based on AUTOSAR may be reduced.

The effects of the present disclosure are not limited to the above-described effects, and other effects that are not mentioned may be obviously understood by those skilled in the art from the following description.

### BRIEF DESCRIPTION OF THE DRAWINGS

FIG. 1 is a diagram illustrating an AUTOSAR standard structure.

FIG. 2 is a diagram illustrating a standard BSW structure of AUTOSAR.

FIG. 3 is a flowchart of a method for generating and verifying automotive embedded software according to an embodiment of the present disclosure.

FIG. 4 is a flowchart of a method for generating and verifying automotive embedded software according to another embodiment of the present disclosure.

FIG. 5 is a diagram for describing an entire system in which an embodiment of the present disclosure is implemented.

FIGS. 6A and 6B are diagrams for describing a configuration of automotive embedded software at a source level.

FIGS. 7A and 7B are diagrams for describing a configuration of automotive embedded software at a binary level.

FIG. 8 is a diagram illustrating a configuration of an automotive embedded software package for ECU virtualization in an embodiment of the present disclosure.

FIG. 9 is a diagram for describing an AUTOSAR configuration tool included in the automotive embedded software package in the embodiment of the present disclosure.

FIG. 10 is a diagram illustrating a BSW structure part according to an embodiment of the present disclosure.

FIG. 11 is a diagram for describing CAN and CAN FD parts in the BSW structure in the embodiment of the present disclosure.

FIG. 12 is a diagram for describing a process of generating an AUTOSAR communication stack in the BSW in the embodiment of the present disclosure.

FIGS. 13A and 13B are diagrams illustrating a CAN communication substructure of the BSW structure in an embodiment of the present disclosure.

FIG. 14 is a diagram for describing a CAN communication software call structure in an embodiment of the present disclosure.

FIG. 15 is a diagram for describing a diagnostic module part of the BSW structure in the embodiment of the present disclosure.

FIG. 16 is a diagram illustrating an example of an integrated simulation environment to which an embodiment of the present disclosure is applied.

FIG. 17 is a diagram for describing a data exchange process in the integrated simulation environment of FIG. 16.

### DETAILED DESCRIPTION

Various advantages and features of the present disclosure and methods accomplishing them will become apparent from the following description of embodiments with reference to the accompanying drawings. However, the present disclosure is not limited to embodiments to be described below, but may be implemented in various different forms, these embodiments will be provided only in order to make the present disclosure complete and allow those skilled in the art to completely recognize the scope of the present disclosure, and the present disclosure will be defined by the scope of the claims.

Terms used in the present specification are for describing embodiments rather than limiting the present disclosure. Unless otherwise stated, a singular form includes a plural form in the present specification. “Comprise” and/or “comprising” used in the present disclosure indicate(s) the presence of stated components but do(es) not exclude the presence or addition of one or more other components. Like reference numerals refer to like components throughout the specification and “and/or” includes each of the components described and includes all combinations thereof. Although “first,” “second,” and the like are used to describe various components, it goes without saying that these components are not limited by these terms. These terms are used only to distinguish one component from other components. Therefore, it goes without saying that a first component described below may be a second component within the technical scope of the present disclosure.

Unless defined otherwise, all terms (including technical and scientific terms) used in the present specification have the same meanings commonly understood by those skilled in the art to which the present disclosure pertains. In addition, terms defined in a commonly used dictionary are not ideally or excessively interpreted unless explicitly defined otherwise.

Hereinafter, after the background from which the present disclosure was derived will be described to help those skilled in the art understand, a method for generating and verifying automotive embedded software based on AUTOSAR according to an embodiment of the present disclosure will be described in detail based on the background.

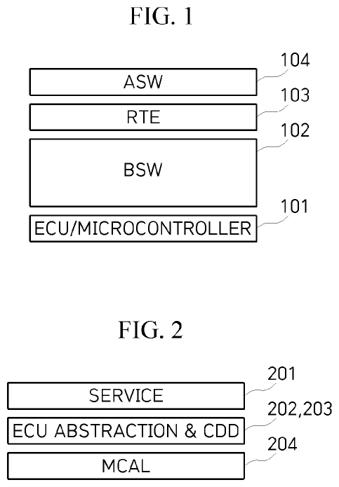

FIG. 1 is a diagram illustrating an AUTOSAR standard structure.

AUTOSAR is a global partnership in a vehicle-related field established in 2003, and is to develop and establish open standard software architecture for a vehicle ECU. Specific goals include scalability across different vehicle and platform variants, consideration of transferability, availability, and safety requirements of software, cooperation between different partners, sustainable use of natural resources, and scalability for maintainability across the entire product lifecycle.

A structure of a general vehicle system guided by the AUTOS is composed of basic software (BSW) 102, runtime environment (RTE) 103, and application software (ASW) 104.

The ASW 104 is an application software layer and is a set of software components. The ASW 104 is a software component, and implements core functions unique to a controller to be developed by OEMs, suppliers, etc.

The RTE 103 serves to exchange and connect data between components of the ASW 104 and between the ASW 104 and the BSW 102. Software components implemented in the ASW 104 through the RTE 103 may be used through an API call without any modification.

The BSW 102 separates hardware and software to provide independent application services to hardware. That is, the BSW 102 is a standardized software layer that provides services necessary for software components to perform necessary tasks, and provides services related to input/output, memory, and communication to software components.

Finally, an electronic control unit (ECU) 101 is the actual hardware on which the automotive embedded software is driven, and corresponds to a basic unit for vehicle control.

FIG. 2 is a diagram illustrating a standard BSW structure of AUTOSAR.

Among the AUTOSAR layers, BSW largely includes a service layer 201, an ECU abstraction layer 202, a microcontroller abstraction layer (MCAL) 204, and complex device drivers (CDD) 203.

The service layer 201 is the uppermost layer among the BSW layers, and provides a system service, a memory service, a communication service, and the like for system operation and overall control of other modules in the BSW.

In this case, the system service performs a function of managing tasks and interrupts. The memory service performs functions for reading and writing to and from memory. The communication service provides functions necessary to use various communication protocols in an automotive embedded system.

Next, the ECU abstraction layer 202 provides an ECU-independent interface to a service layer and an ASW layer. As an embodiment, various memory interfaces and communication interfaces may be implemented according to the ECU through the ECU abstraction layer 202.

Next, the MCAL 204 provides a microcontroller-independent specific interface to the abstraction layer. When the AUTOSAR is applied to a microcontroller with a different design, it is possible to call communication, memory, and input/output modules regardless of the microcontroller by using a driver of the MCAL 204.

Finally, the CDD 203 is a layer that configures a direct interface from the microcontroller to RTE without being connected to the specific layer, and may allow information of the BSW to be directly transmitted to the ASW through the RTE. The CDD 203 may be used by adding a driver or the like for functions not defined in the AUTOSAR.

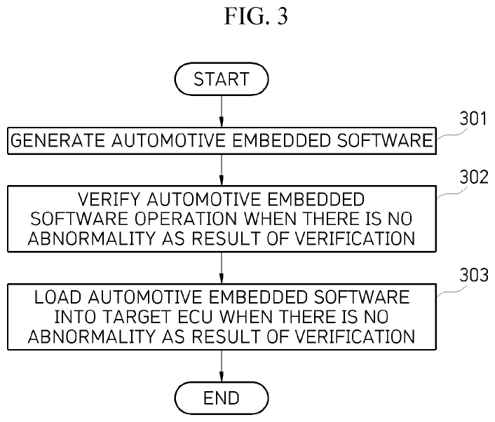

Hereinafter, a method for generating and verifying automotive embedded software based on AUTOSAR according to an embodiment of the present disclosure will be described with reference to FIG. 3 to 9.

FIG. 3 is a flowchart of a method for generating and verifying automotive embedded software according to an embodiment of the present disclosure.

First, among the layers constituting the AUTOSAR for the automotive embedded software, the RTE and BSW are emulated to fit a predetermined test environment to generate automotive embedded software (301).

Next, the operation of the automotive embedded software based on the AUTOSAR implemented to correspond to the predetermined test target function is verified (302), and if there is no abnormality as a result of the verification, the automotive embedded software is loaded into a target ECU (303).

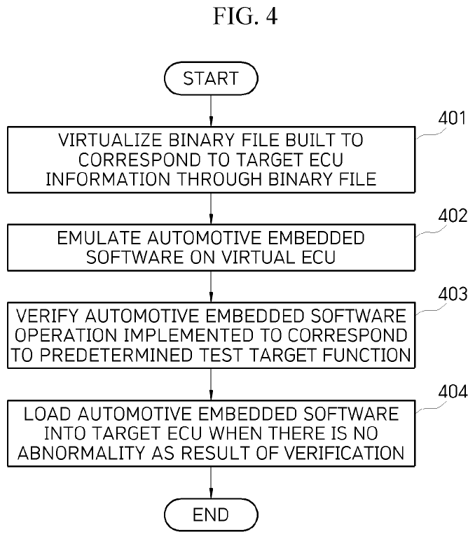

FIG. 4 is a flowchart of a method for generating and verifying automotive embedded software according to another embodiment of the present disclosure.

First, a binary file built to correspond to the target ECU information is virtualized through QEMU (401), and the automotive embedded software based on AUTOSAR to be verified is emulated to fit a predetermined test environment on the virtualized ECU (hereinafter, referred to as a virtual ECU) to generate the automotive embedded software (402).

Next, the operation of the AUTOSAR implemented to correspond to the predetermined test target function is verified (403), and if there is no abnormality as a result of the verification, the automotive embedded software is loaded into the target ECU (404).

In this case, the embodiment described in FIG. 3 corresponds to a method for generating and verifying a source level (CAT 1), and the embodiment described in FIG. 4 corresponds to a method for generating and verifying a binary level (CAT 2).

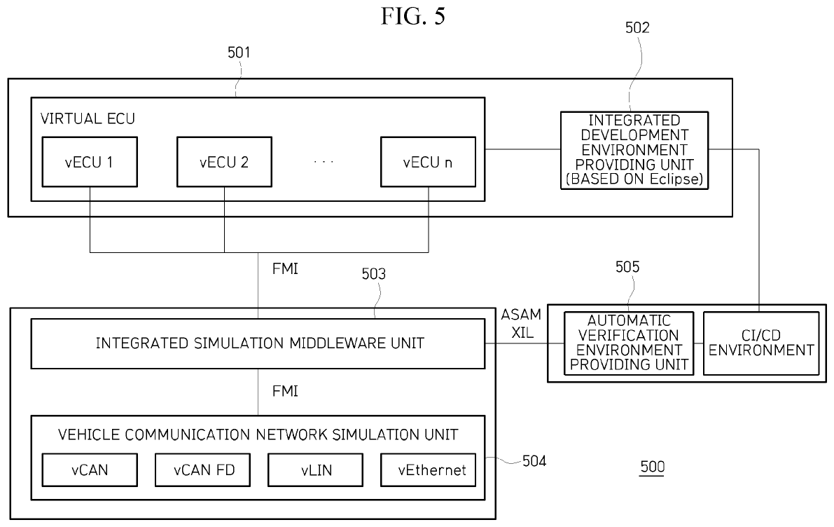

FIG. 5 is a diagram for describing an entire system in which an embodiment of the present disclosure is implemented.

A system 500 for verifying automotive embedded software based on AUTOSAR according to an embodiment of the present disclosure includes a virtual ECU 501, an integrated development environment providing unit 502, an integrated simulation middleware unit 503, a vehicle communication network simulation unit 504, and an automatic verification environment providing unit 505.

The virtual ECU 501 means all virtualized hardware and automotive embedded software to be generated or verified through the source level or the binary level. The virtual ECU 501 may include a plurality of virtualized ECUs according to provided functions.

The integrated development environment providing unit 502 is connected to the virtual ECU 501, and may debug image files built through the source level (CAT 1) or binary level (CAT 2) method by utilizing Eclipse and QEMU plug-in.

The integrated simulation middleware unit 503 operates by being connected to a plurality of virtualized ECUs (vECUs) 501, a vehicle communication network simulation unit 504, etc., through a functional mockup interface (FMI), and exchanges a functional mockup unit (FMU) through the FMI. In this case, the FMU becomes a simulator of a specific unit, but since the FMU is independent of the processor, when the hardware is connected instead of the FMU when the actual hardware is available, the simulation may be hardware in the loop simulation (HILS) naturally.

The vehicle communication network simulation unit 504 analyzes information collected from the virtual ECU 501 and simulates a specific communication interface between ECUs to enable data exchange. For example, the vehicle communication network simulation unit 504 may include vCAN, vCAN FD, vLIN, and vEthernet.

Lastly, the automatic verification environment providing unit 505 supports the ASAM XIL-MA interface to support the exchange of a testcase between the vehicle communication network simulation unit 504 and a third party tool.

Hereinafter, the method for generating and verifying automotive embedded software at the source level and the binary level performed by the entire system described above will be described in more detail.

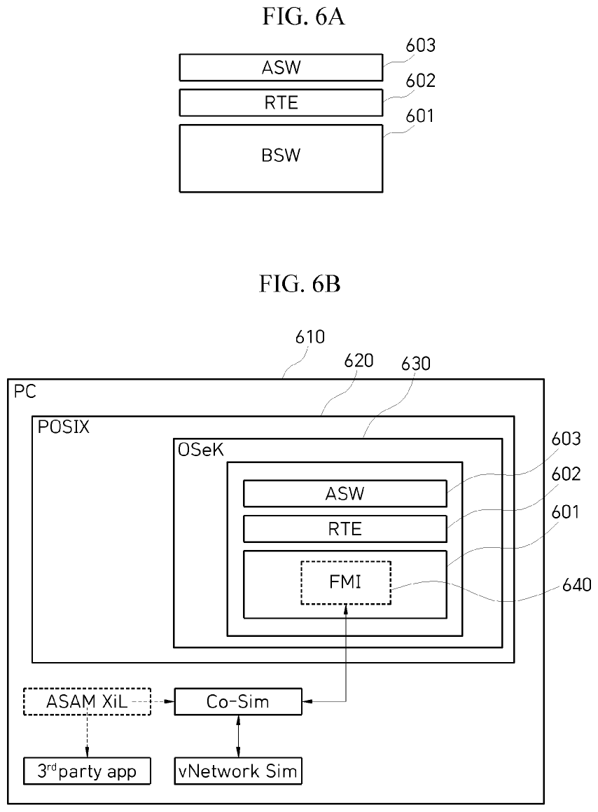

FIGS. 6A and 6B are diagrams for describing a configuration of automotive embedded software at a source level.

First, FIG. 6A illustrates a configuration of automotive embedded software at a source level, which has a structure capable of developing and verifying the automotive embedded software when it is difficult to obtain the image file of the target ECU. The source level technique is a method for emulating RTE 602, BSW 601, OS, and MCAL except for ASW 603 in PC/server environment with operable software to implement a vehicle ECU virtualization environment. That is, the source level technique focuses on verifying the operation of the ASW 603, the BSW 601, and the RTE 602, and does not consider the ECU.

Next, FIG. 6B illustrates in more detail the configuration of FIG. 6A. In one embodiment of the present disclosure, Offene Systeme und deren Schnittstellen ftir die Elektronik in Kraftfahrzeugen (OSEK) 630 may be driven based on an operating system interface based on a portable operating system interface (POSIX) 620 operating on PC 610 as a predetermined test environment, and the automotive embedded software based on the AUTOSAR may be driven based on an API of the OSEK 630.

That is, in the case of the source level method in one embodiment of the present disclosure, the AUTOSAR is driven based on the POSIX 620 on the PC 610. In this case, the POSIX 620 is an application interface standard formulated by the IEEE for the purpose of developing a highly portable Unix application program by arranging common APIs of different Unix OSes. Through the POSIX 620, it is possible to execute application programs regardless of the operating system.

In addition, the OSEK 630 is an operating system for the automotive embedded system, and refers to a real-time operating system for vehicles as a standard specification itself for generating a communication stack and a network management protocol.

According to an embodiment of the present disclosure, the OSEK 630 operates based on the POSIX 620 based on each operating system, and the AUTOSAR may be driven using the API of the OSEK 630. However, unlike the existing AUTOSAR standard, the embodiment of the present disclosure supports FMI 640 within the AUTOSAR.

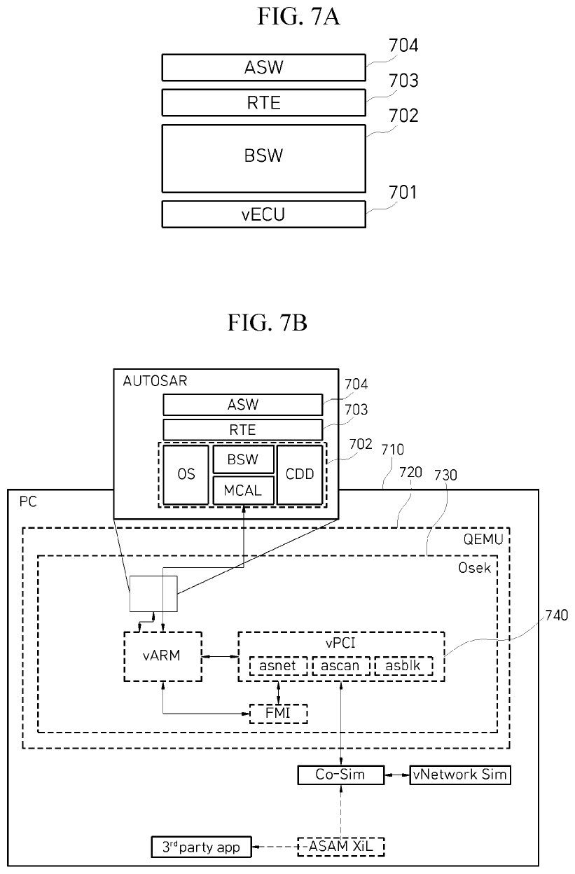

FIGS. 7A and 7B are diagrams for describing a configuration of automotive embedded software at a binary level.

First, referring to FIG. 7A, in the case of the binary level, there is specific hardware to drive the automotive embedded software, but when there is no actual hardware, the specific hardware is virtualized and emulated on the QEMU. That is, the automotive embedded software can be verified by executing the binary file of the automotive embedded software on virtualized hardware. This binary level method may verify the entire operation before the provided binary file of the automotive embedded software is loaded into the target ECU.

Next, FIG. 7B illustrates in more detail the configuration of FIG. 7A. In an embodiment of the present disclosure, OSEK 730 is driven on a virtualized ECU 701 through QEMU 720 on PC 710 as a predetermined test environment, and the AUTOSAR may be driven based on an API of the OSEK 730. In this case, since the QEMU 720 is in an isolated state, a communication port should be opened on the QEMU 720 for communication. According to an embodiment of the present disclosure, network data may be transmitted and received through a virtualized PCI 740 formed for communication of the QEMU 720.

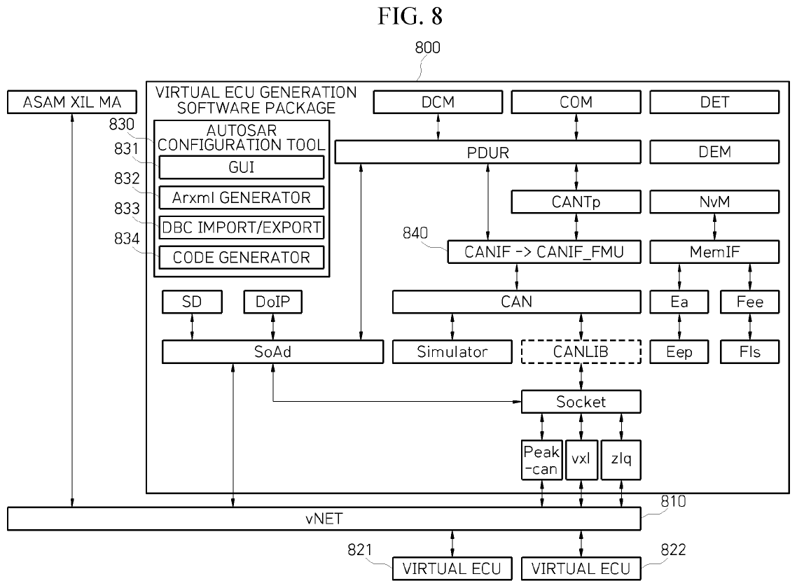

FIG. 8 is a diagram illustrating a configuration of an automotive embedded software package 800 for ECU virtualization in an embodiment of the present disclosure.

FIG. 8 illustrates the automotive embedded software package 800 configured to support data exchange according to the AUTOSAR 3 version standard. In this case, according to an embodiment of the present disclosure, CANIF defined in the AUTOSAR standard was replaced with CANIF_FMU for network simulation (840). Details related to this will be described later.

As an embodiment, communication between virtual ECUs 821 and 822 on the automotive embedded software package 800 may exchange data through the virtual network 810. In this case, the virtual network 810 corresponds to an integrated simulation middleware unit and a vehicle communication network simulation unit.

A data exchange process between the virtual ECUs 821 and 822 is as follows. For data exchange between vECU1 821 and vECU2 822, data is first transmitted from the vECU1 821 to the virtual network 810. Then, the integrated simulation middleware unit and the vehicle communication network simulation unit process the transmitted data and then transmit data to the vECU2 822.

In this case, the vehicle communication network simulation unit may acquire information such as operating states of the vECUs 821 and 822. In addition, when the vehicle communication network simulation unit generates and transmits data to be simulated to a specific vECU, vECU simulation is possible by using the corresponding data in the vECU. Testcases used in this process may be provided through a vehicle communication network simulator tool or may be provided through a third party tool.

Meanwhile, it may be difficult to exchange the testcases because the interface for executing the testcases generated by each tool is different. In order to solve this problem, according to an embodiment of the present disclosure, an ASAM XiL-MA interface is provided to enable the exchange of the testcases.

In addition, the automotive embedded software package in an embodiment of the present disclosure may include an AUTOSAR configuration tool 830. The AUTOSAR configuration tool 830 is provided as a part of the software package 800 for virtual ECU generation, and may include a graphic user interface (GUI) 831 that executes the configuration tool 830, an ARXML generator 832 that generates a source code of AUTOSAR software, a DBC import/export 833 that software-reflects CANDB including data transmission information for CAN communication or extracts and stores signals, and a source code generator 834 that generates codes using ARXML.

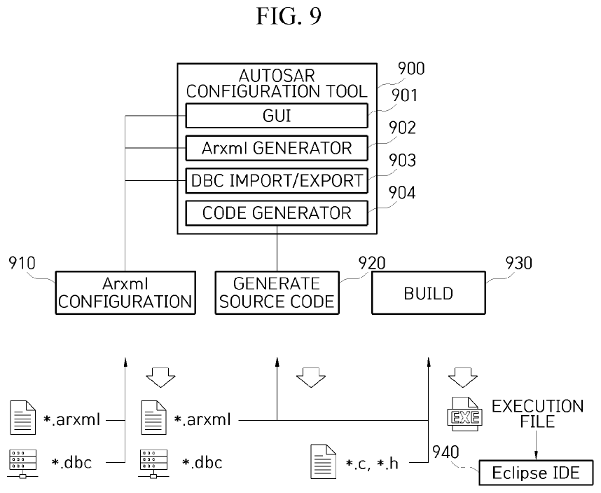

FIG. 9 is a diagram for describing the AUTOSAR configuration tool included in the automotive embedded software package in the embodiment of the present disclosure.

FIG. 9 is a diagram for describing a process of building and debugging an AUTOSAR configuration tool 900 according to an embodiment of the present disclosure. For the automotive embedded software configuration, first, pre-set Arxm1 is read through the GUI 901 for Arxm1 setting, and the dbc file for CAN communication is imported or exported.

When the Arxm1 configuration is completed through the ARXML generator 902 (910), the source code is generated through the source code generator 904 (920). The generated source code is generated as an executable file through a compiling and building process (930). In this case, in the case of the source level method, the automotive embedded software driven based on the POSIX is generated as the executable file, and in the case of the binary level method, the virtual ECU and the automotive embedded software driven in the virtual ECU are generated as the executable file.

When the executable file generated in this way is loaded into Eclipse IDE in the plug-in format, it is possible to emulate and debug the executable file is possible (940).

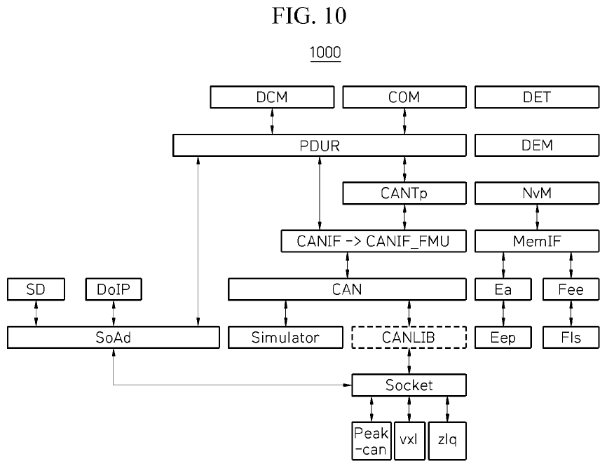

Hereinafter, a BSW part in the automotive embedded software package configuration for ECU virtualization in FIG. 7 described above will be described in detail with reference to FIG. 10 to 17.

FIG. 10 is a diagram illustrating a BSW structure part 1000 according to an embodiment of the present disclosure.

An embodiment of the present disclosure supports the standard API of the AUTOSAR, and configures the BSW as illustrated in FIG. 10 by reconfiguring the automotive embedded software package (1000).

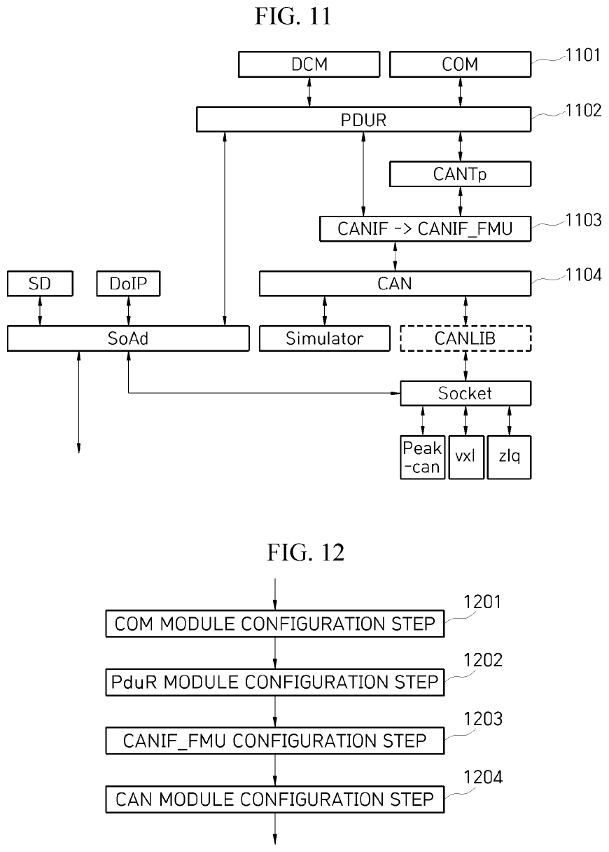

First, a process of generating an AUTOSAR communication stack in the BSW configuration will be described with reference to FIG. 11 to 13.

FIG. 11 is a diagram for describing CAN and CAN FD parts in the BSW structure in the embodiment of the present disclosure. FIG. 12 is a diagram for describing a process of generating the AUTOSAR communication stack in the BSW in the embodiment of the present disclosure.

In an embodiment, the AUTOSAR communication stack in the BSW includes a COM module 1101, a Pdu Router (PduR) module 1102, a CANIF_FMU module 1103, and a CAN module 1104.

First, the COM module 1101 that transmits data received from the RTE to the PduR module 1102 in a PDU type is generated (1201). In this case, the PDU means an abstracted protocol for message transmission between layers.

Signal data transmitted from the COM module 1101 means a message itself to be transmitted internally and externally. The signal transmitted through the RTE in the software component is stored in an I-PDU buffer in the COM module 1101, and transmitted to the PduR module 1102 in the I-PDU type, or transmitted to a software component connected to the corresponding signal by analyzing the signal included in the I-PDU.

Next, the PduR module 1102 that transmits the data received from the COM module 1101 to the CANIF_FMU module 1103 or transmits the data received from the CANIF_FMU module 1103 to the COM module 1101 is configured (1202).

The PduR module 1102 configures a routing table. In this case, the routing table is a table defining a bundle of signals to be exchanged through communication and an end point of the bundle of the signals. Accordingly, the PduR module 1102 may transmit the signal transmitted from the RTE to the COM module 1101 to the CANIF_FMU module 1103 as the end point of the signal, or transmit (route) the signal input to the CANIF_FMU module 1103 to the COM module 1101 as the end point of the corresponding signal.

Next, the CANIF_FMU module 1103, which selects an internal channel based on the PDU identifier and transmits the PDU to a hardware object handle (HOH) connected to each channel, is configured (1203).

Next, the CAN module 1104 that writes the PDU transmitted through the CANIF_FMU module 1103 to a hardware object of the CAN controller is configured (1204). In this case, an object flag is set to 1, and when an object flag value is 1, CAN data is transmitted through a transceiver.

Meanwhile, according to an embodiment of the present disclosure, CANIF_FMU is applied instead of the CANIF of the AUTOSAR standard, and the data exchange of the FMU is possible through the CANIF_FMU module 1103.

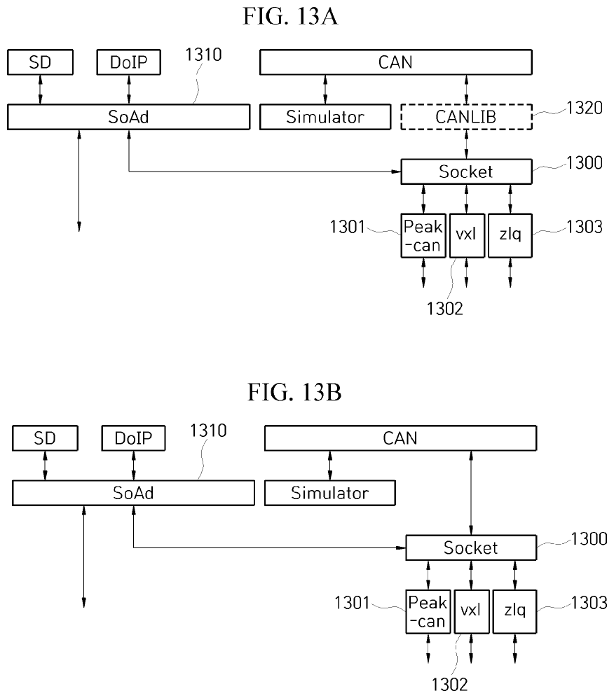

FIGS. 13A and 13B are diagrams illustrating a CAN communication substructure of the BSW structure in an embodiment of the present disclosure.

Referring to FIGS. 13A and 13B, according to an embodiment of the present disclosure, there is a need to virtualize the transceiver for the CAN communication to enable the operation at the source level and the binary level.

To this end, according to an embodiment of the present disclosure, a socket module 1300, which provides a socket function of a predetermined manufacturer for supporting a CAN network with a CAN module, may be configured. In this case, examples of the socket for the CAN network may be VXL CAN 1302 of Vector Co., Peak 1301 of Peak Co., and Can hardware interface 1303 of ZLG Co. Here, communication simulation of CAN FD is possible through the VXL CAN 1302. Meanwhile, the socket may include a socket for Linux and a socket for Windows to be supported in Windows and Linux.

In addition, according to an embodiment of the present disclosure, a socket adapter module 1310 may be configured to support TCP/IP-based data communication in the environment where a CAN-based hardware interface is not provided.

Meanwhile, in the AUTOSAR communication stack in an embodiment of the present disclosure, in the case of the source level method, a CAN library module 1320 is provided between the socket module and the CAN module to simulate the data communication environment on the CAN-based hardware interface (FIG. 13A). On the other hand, since the binary level method includes the information of the target ECU, unlike the source level method, the CAN library module 1320 does not need to be provided (FIG. 13B).

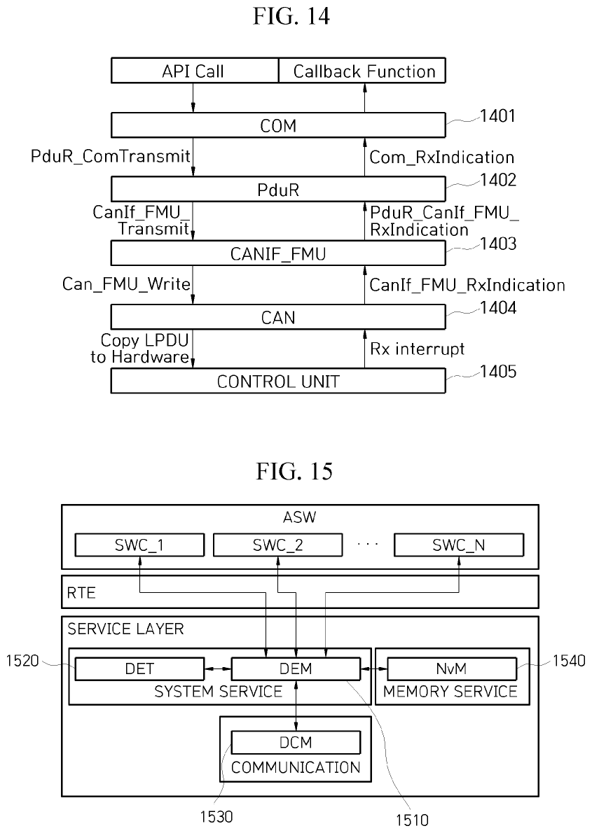

FIG. 14 is a diagram for describing a CAN communication software call structure in an embodiment of the present disclosure.

Referring to FIG. 14, according to an embodiment of the present disclosure, as the CAN communication API is called, a COM module 1401 transmits data received from the RTE to a PduR module 1402 in the PDU type through a PduR_ComTransmit function.

Next, the PduR module 1402 calls the CanIf_FMU_Transmit function to transmit the PDU-type data to the CANIF_FMU module 1403.

Next, the CANIF_FMU module 1403 calls a Can_FMU_Write function, which is an FMU write function, to convert PDU-type data into an EMU type, and then transmits the FMU type data to a CAN module 1404.

Next, the CAN module 1404 records data received from the CANIF_FMU module 1403 in a CAN control unit 1405.

Thereafter, when an interrupt (Rx interrupt) related to reception is generated from the CAN control unit 1405 and is received by the CAN module 1404, the CAN module 1404 calls a CanIf_FMU_RxIndication function, which is a reception indicator function, to the CANIF_FMU module 1403 to generate an interrupt related to reception of FMU-type data.

Then, the CANIF_FMU module 1403 may call a Pdur_CanIf_FMU_RxIndication function to convert the data converted into the FMU type into PDU-type data and transmit the PDU-type data to the PduR module 1402, in which the corresponding data may be transmitted to the RTE through the COM module 1401.

FIG. 15 is a diagram for describing a diagnostic module part of the BSW structure in the embodiment of the present disclosure.

The diagnostic module performing a diagnosis function in the BSW structures according to an embodiment of the present disclosure may include a DEM module 1510, a DET module 1520, and a DCM module 1530.

As an embodiment, the DEM module 1510 is included in a service layer (system service) of the BSW, and processes diagnostic events and stores event-related information in a NVRAM manager (NvM) 1540. In addition, the DEM module 1510 may transmit diagnostic information to the DCM module 1530.

As an embodiment, the DET module 1520 is a module used in the development process and provides an API for reporting an error. When the function of the DET module 1520 is used, a function for collecting errors may be added to modules belonging to the BSW.

As an embodiment, the DCM module 1530 is included in a service layer (communication service) and is used for a communication test with an external tool. The DCM module 1530 receives a request from a test tool and returns information according to the request. In addition, the DCM module 1530 may return a code meaning positive or negative through validation verification in the process of processing the request (that is, processing an error related to communication).

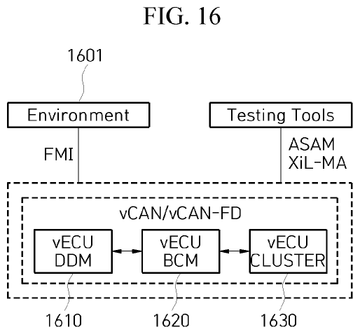

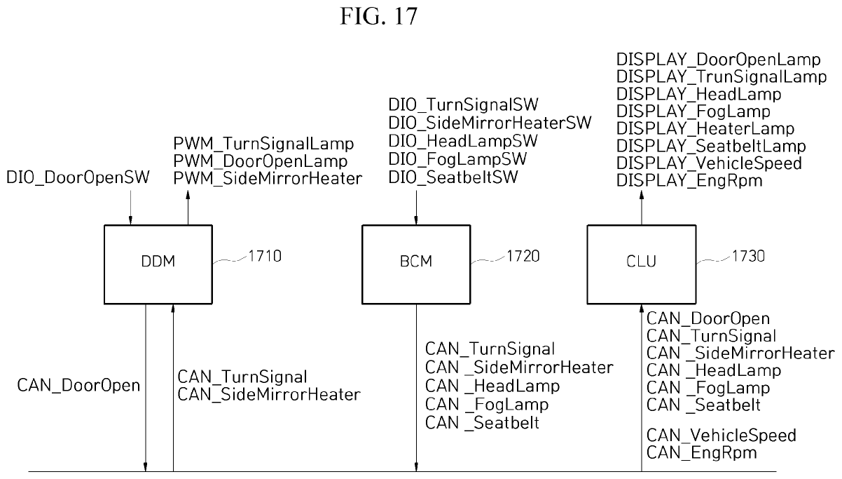

Hereinafter, an application example of an embodiment of the present disclosure will be described with reference to FIGS. 16 and 17.

FIG. 16 is a diagram illustrating an example of an integrated simulation environment to which an embodiment of the present disclosure is applied. FIG. 17 is a diagram for describing a data exchange process in the integrated simulation environment of FIG. 16.

FIG. 16 illustrates a simulation environment in which the automotive embedded software based on AUTOSAR for a door drive module (DDM), a body control module (BCM) 1620, and a cluster 1610 are loaded into a virtual ECU. The integrated development environment providing unit 1601 extracts a signal from the data that simulates the CAN and the CAN FD through the FMU received through the FMI, executes a command according to the signal, and returns the result to the vehicle communication network simulator unit through the FMI. In addition, it is possible to transmit and receive test data to and from third-party apps through ASMA XiL MA.

Referring to FIG. 17, first, DIO_{Signal}SW, which is a digital input/output signal, means a signal generated by a software component that uses {Signal}. For example, DIO_TurnSignalSW is a signal generated when TurnSignal is turned on or off in a vehicle.

When any of TurnSignal, SideMirror, HeatLamp, FogLamp, or Seatbelt signal is generated, the FMU including the CAN frame is transmitted to the virtual network. In the virtual network, information on the corresponding signal is stored and FMUed information is transmitted.

Since signals that may be received from CANIF_FMU are predefined for each virtual ECU, each virtual ECU receives only data that the ECU can use among the generated signals. Therefore, when the DIO_TurnSignalSW signal is generated in a BCM module 1720, CAN_TurnSignal may be transmitted to the virtual network, and the DDM module 1710 may provide a PWM signal through PWM_TurnSignalLamp as the CAN_TurnSignal signal is generated to provide a blinking signal to a turn signal lamp of a side mirror. In addition, as the CAN_TurnSignal signal is transmitted to a cluster module 1730, the DISPLAY_TurnSignalLamp signal is generated, and thus, an indicator light icon flickers.

As another example, when a door open detection sensor of the DDM module 1710 detects a door open, a DIO_DoorOpenSW signal is generated, and in order to operate a lamp on the door side according to the door open, the PduR module extracts a signal from the data stored in the I-PDU, and transmits the signal to the software component through the RTE to generate a PWM signal through PWM_DoorOpenLamp, so that the lamp may be turned on. In addition, a CAN_DoorOpen signal is sent out through the virtual network, and the corresponding signal is transmitted to the cluster module 1730 to generate a DISPLAY_DOOROPEN signal, so the door open icon of the cluster may be turned on.

The method for verifying automotive embedded software based on AUTOSAR according to an embodiment of the present disclosure described above may be implemented as a program (or application) to be executed in combination with a computer, which is hardware, and stored in a medium.

In order for the computer to read the program and execute the methods implemented as the program, the program may include a code coded in a computer language such as C, C++, JAVA, Ruby, or machine language that the processor (CPU) of the computer may read through a device interface of the computer. Such code may include functional code related to a function or such defining functions necessary for executing the methods and include an execution procedure related control code necessary for the processor of the computer to execute the functions according to a predetermined procedure. In addition, the code may further include a memory reference related code for which location (address street number) in an internal or external memory of the computer the additional information or media necessary for the processor of the computer to execute the functions is to be referenced at. In addition, when the processor of the computer needs to communicate with any other computers, servers, or the like located remotely in order to execute the above functions, the code may further include a communication-related code for how to communicate with any other computers, servers, or the like using the communication module of the computer, what information or media to transmit/receive during communication, and the like.

The storage medium is not a medium that stores images therein for a while, such as a register, a cache, a memory, or the like, but means a medium that semi-permanently stores the images therein and is readable by an apparatus. Specifically, examples of the storage medium include, but are not limited to, ROM, random-access memory (RAM), CD-ROM, a magnetic tape, a floppy disk, an optical image storage device, and the like. That is, the program may be stored in various recording media on various servers accessible by the computer or in various recording media on the computer of the user. In addition, media may be distributed in a computer system connected by a network, and a computer-readable code may be stored in a distributed manner.

The above description of the present disclosure is for illustrative purposes, and those skilled in the art to which the present disclosure pertains will understand that it may be easily modified to other specific forms without changing the technical spirit or essential features of the present disclosure. Therefore, it is to be understood that the embodiments described hereinabove are illustrative rather than being restrictive in all aspects. For example, each component described as a single type may be implemented in a distributed manner, and similarly, components described as distributed may be implemented in a combined form.

It is to be understood that the scope of the present disclosure will be defined by the claims rather than the above-described description and all modifications and alternations derived from the claims and their equivalents are included in the scope of the present disclosure.

What is claimed is:

1. A method for verifying automotive embedded software based on AUTOSAR, comprising:
emulating RTE and BSW among layers constituting the AUTOSAR for the automotive embedded software to be verified to fit a predetermined test environment;
verifying an operation of the automotive embedded software based on AUTOSAR implemented to correspond to a predetermined test target function; and
loading the automotive embedded software into a target ECU when there is no abnormality as a result of the verification.

2. The method of claim 1, wherein, in the emulating of the RTE and BSW among the layers constituting the AUTOSAR for the automotive embedded software to be verified to fit the predetermined test environment, OSEK is driven based on a POSIX-based operating system interface operating on PC as the predetermined test environment, and the AUTOSAR is driven based on an API of the OSEK.

3. The method of claim 2, wherein, in the emulating of the RTE and BSW among the layers constituting the AUTOSAR for the automotive embedded software to be verified to fit the predetermined test environment, FMI is supported in the BSW among the layers of the AUTOSAR.

4. The method of claim 3, wherein the emulating of the RTE and BSW among the layers constituting the AUTOSAR for the automotive embedded software to be verified to fit the predetermined test environment includes generating an AUTOSAR communication stack in the BSW, and
the generating of the AUTOSAR communication stack in the BSW includes:
configuring a COM module that transmits data received from the RTE to a PduR module in a PDU type;
configuring a PduR module that transmits data received from the COM module to a CANIF_FMU module or transmits data received from the CANIF_FMU module to the COM module;
configuring a CANIF_FMU module that selects an internal channel based on a PDU identifier and transmits the PDU to a hardware object handle (HOH) connected to each channel; and
configuring a CAN module to record the PDU transmitted through the CANIF_FMU module in a hardware object of a CAN controller.

5. The method of claim 4, wherein the CANIF_FMU module calls an FMU write function to convert the PDU-type data into an FMU type and transmit the FMU-type data to the CAN module, and
the CAN module calls a reception indicator function to the CANIF_FMU module to generate an interrupt regarding reception of the FMU-type data, and the CANIF_FMU module converts the data converted into the FMU-type data into the PDU-type data and transmits the PDU-type data to the module.

6. The method of claim 3, wherein the generating of the AUTOSAR communication stack in the BSW includes:
configuring a socket module that provides a socket function of a predetermined manufacturer for supporting a CAN network with the CAN module;
configuring a CAN library module provided between the socket module and the CAN module to simulate a data communication environment on a CAN-based hardware interface; and
configuring a socket adapter module supporting TCP/IP-based data communication in an environment where the CAN-based hardware interface is not provided.

7. The method of claim 1, further comprising:
virtualizing a binary file built to correspond to the information of the target ECU through QEMU,
wherein, in the emulating of the RTE and BSW among the layers constituting the AUTOSAR for the automotive embedded software to be verified to fit the predetermined test environment, the automotive embedded software is emulated to fit the predetermined test environment on the virtualized ECU (hereinafter, referred to as a virtual ECU).

8. The method of claim 7, wherein, in the emulating of the RTE and BSW among the layers constituting the AUTOSAR for the automotive embedded software to be verified to fit the predetermined test environment, OSEK is driven on the virtualized ECU through the QEMU on PC as the predetermined test environment, and the AUTOSAR is driven based on an API of the OSEK.

9. The method of claim 8, wherein, in the emulating of the RTE and BSW among the layers constituting the AUTOSAR for the automotive embedded software to be verified to fit the predetermined test environment, network data is transmitted and received through virtualized PCI formed for communication of the QEMU.

10. A method for verifying automotive embedded software based on AUTOSAR, the method comprising:
virtualizing a binary file built to correspond to target ECU information through QEMU;
emulating the automotive embedded software based on the AUTOSAR to be verified on the virtualized ECU (hereinafter, referred to as a virtual ECU) to fit a predetermined test environment;
verifying an operation of the automotive embedded software based on AUTOSAR implemented to correspond to a predetermined test target function; and
loading the automotive embedded software into a target ECU when there is no abnormality as a result of the verification.

11. The method of claim 10, wherein, in the emulating of the automotive embedded software based on the AUTOSAR to be verified on the virtualized ECU to fit the predetermined test environment, OSEK is driven on the virtualized ECU through the QEMU on PC as the predetermined test environment, and the AUTOSAR is driven based on an API of the OSEK.

12. The method of claim 11, wherein, in the emulating of the automotive embedded software based on the AUTOSAR to be verified on the virtualized ECU to fit the predetermined test environment, network data is transmitted and received through a virtualized PCI formed for communication of the QEMU.

13. The method of claim 11, wherein the emulating of the automotive embedded software based on the AUTOSAR to be verified on the virtualized ECU to fit the predetermined test environment includes generating an AUTOSAR communication stack in the BSW of the AUTOSAR, and
the generating of the AUTOSAR communication stack in the BSW of the AUTOSAR includes:
configuring a COM module that transmits data received from the RTE to a PduR module in a PDU type;
configuring a PduR module that transmits data received from the COM module to a CANIF_FMU module or transmits data received from the CANIF_FMU module to the COM module;
configuring a CANIF_FMU module that selects an internal channel based on a PDU identifier and transmits the PDU to a hardware object handle (HOH) connected to each channel; and
configuring a CAN module to record the PDU transmitted through the CANIF_FMU module in a hardware object of a CAN controller.

14. The method of claim 13, wherein the CANIF_FMU module calls an FMU write function to convert the PDU-type data into an FMU type and transmit the FMU-type data to the CAN module, and
the CAN module calls a reception indicator function to the CANIF_FMU module to generate an interrupt regarding reception of the FMU-type data, and the CANIF_FMU module converts the data converted into the FMU-type data into the PDU-type data and transmits the PDU-type data to the module.

15. The method of claim 12, wherein the generating of the AUTOSAR communication stack in the BSW of the AUTOSAR includes:
configuring a socket module that provides a socket function of a predetermined manufacturer for supporting a CAN network with the CAN module; and
configuring a socket adapter module supporting TCP/IP-based data communication in an environment where the CAN-based hardware interface is not provided.

16. A method for generating automotive embedded software based on AUTOSAR, the method comprising:
emulating RTE and BSW among layers constituting the AUTOSAR for the automotive embedded software to fit a predetermined test environment,
wherein FMI is supported in the BSW among the layers of the AUTOSAR.

17. The method of claim 16, wherein the emulating of the RTE and BSW among the layers constituting the AUTOSAR for the automotive embedded software to fit the predetermined test environment includes generating an AUTOSAR communication stack including a COM module, a PduR module, a CANIF_FMU module, and a CAN module in the BSW.

18. The method of claim 17, wherein the generating of the AUTOSAR communication stack including the COM module, the PduR module, the CANIF_FMU module, and the CAN module in the BSW includes:
configuring a COM module that transmits data received from the RTE to a PduR module in a PDU type;
configuring a PduR module that transmits data received from the COM module to a CANIF_FMU module or transmits data received from the CANIF_FMU module to the COM module;
configuring a CANIF_FMU module that selects an internal channel based on a PDU identifier and transmits the PDU to a hardware object handle (HOH) connected to each channel; and
configuring a CAN module to record the PDU transmitted through the CANIF_FMU module in a hardware object of a CAN controller.
